(19) United States
(12) Patent Application Publication
(10) Pub. No.: US 2025/0138844 A1
(43) Pub. Date: May 1, 2025

(54) EXCHANGING USER ENVIRONMENTS OF EDGE COMPUTING SYSTEMS AND HIGH-PERFORMANCE COMPUTING SYSTEMS

(71) Applicant: HEWLETT PACKARD ENTERPRISE DEVELOPMENT LP, Spring, TX (US)

(72) Inventors: Scott J. Hinchley, Spring, TX (US); David S. Brookshire, Spring, TX (US); Aalap Tripathy, Spring, TX (US); Donald M. Bahls, Bloomington, MN (US); Alan D. Mutschelknaus, Bloomington, MN (US)

(21) Appl. No.: 18/497,944

(22) Filed: Oct. 30, 2023

(51) Int. Cl. G06F 9/451; G06N 5/04; G06N 20/00; H04L 9/32

(52) U.S. Cl. CPC G06F 9/451; G06N 5/04; G06N 20/00; H04L 9/32

(57) ABSTRACT

A process includes hosting, on an edge computing system that is external to a high-performance computing system, a user interface instance. The process includes providing, by the user interface instance, a cryptographic authentication token to the high-performance computing system to form a connection between the high-performance computing system and an endpoint instance of the high-performance computing system. The process includes, responsive to providing the cryptographic authentication token, forming a connection between the user interface instance and the endpoint instance. The process includes mounting a first file system of the edge computing system to a second file system of the high-performance computing system to provide an extended first file system. The process includes exchanging a user environment of the edge computing system with a user environment of the high-performance computing system. The exchanging includes, responsive to a request that is received by the user interface instance from the connection, accessing, by the user interface instance, the extended file system to transfer data between the edge computing system and the high-performance computing system.

### BACKGROUND

A high-performance computing (HPC) cluster includes a collection of compute nodes that coordinate their processing activities to achieve a common goal. The compute nodes of an HPC cluster may perform parallel processing on voluminous multi-dimensional datasets for any of a number of purposes, such as scientific research, financial service fraud detection, animation, hydrocarbon reservoir analyses, aircraft design, autonomous automobile design, genomics or any other use case that relies on a solution to solve computationally-complex problems.

### BRIEF DESCRIPTION OF THE DRAWINGS

FIG. 1 is a block diagram of a computer network having an HPC system and an edge computing system according to an example implementation.

FIG. 2 is a sequence flow diagram illustrating configuration of an HPC system to prepare the HPC system to exchange user environments with an edge computing system according to an example implementation.

FIG. 3 is a sequence flow diagram illustrating configuration of an edge computing system to prepare the edge computing system to exchange user environments with an HPC system according to an example implementation.

FIG. 4 is a sequence flow diagram illustrating an operation to transfer data between an HPC system and an edge computing system according to an example implementation.

FIG. 5 is a flow diagram depicting a process to exchange user environments of an HPC system and an edge computing system according to an example implementation.

FIG. 6 is an illustration of machine-readable instructions stored on a non-transitory storage medium, which, when executed by a machine, cause the machine to provide a user interface instance on an edge computing system to extend a data plane of an HPC system to an edge computing system according to an example implementation.

FIG. 7 is a block diagram of an HPC system including a plurality of compute nodes that perform parallel processing jobs and an edge computing system manager endpoint that communicates with an interface instance of an edge computing system to extend a data plane of the HPC system to the edge computing system according to an example implementation.

### DETAILED DESCRIPTION

An HPC system may perform parallel processing to solve computationally-complex problems that benefit an edge computing system. In an example, the edge computing system may be an experimental or instrumentation edge facility that has significant compute, storage and networking resources, as compared to, for example, resource-constrained edge computing systems (e.g., an edge computing system of Internet-of-Things (IoT) devices). Accordingly, large volumes of data may be exchanged between the edge computing system and the HPC system.

Moreover, the computational activities between the systems may be interrelated. In an example, the edge computing system may perform data inference at the edge using machine learning models, and the HPC system may perform related computational tasks, such as machine learning model training and model parameter tuning. Because the edge and the HPC systems may be separate systems that are under different administrative domains, setting up both systems to exchange data may be a daunting challenge. Moreover, data exchanges between the two systems may involve manual intervention, which may be impractical for supporting the interrelated computational activities of the two systems. In accordance with example implementations, the data plane of an HPC system is extended to an edge computing system by deploying a user access interface instance (called the “UAIe instance” herein) on the edge computing system. The UAIe instance provides a strong linkage between the edge computing system and the HPC system, which, among other benefits, simplifies connecting the edge computing system to the HPC system and allows the HPC system to exchange data with the edge computing system in an automated fashion.

The UAIe instance allows the exchange of user environments between the edge computing system and the HPC system. In this context, a “user environment” refers to a framework for accessing resources of a computing system. In an example, a user environment may correspond to particular operating system, file system, application(s), certain resources (e.g., input devices, files, data capture devices, mass storage devices or any other device whose access can be controlled by an operating system) and access privileges. “Exchanging” a first user environment with a second user environment, in the context that is used herein, refers to the creation of a user environment that has elements from both the first and second user environments. In an example, an UAIe instance may provide a user environment that has a software stack (e.g., an operating system, middleware, virtualization components, applications and other features) and a file system that is familiar to users of the edge computing system. Moreover, continuing the example, the UAIe instance may provide elements from a user environment of the HPC system, such as, for example, a shared file system and access privileges of the HPC system. Because the UAIe instance is hosted on the edge computing system, laboratory workflows on the edge computing system may be executed within the UAIe instance's context. Moreover, immediate control of experiments may be managed by an experimentalist in a consistent user environment familiar to developers and scientists alike.

In accordance with example implementations, setting up the HPC and edge computing systems to use the UAIe instance involves actions that are taken in both the administrative domains of both systems. On the HPC system side, the actions include creating an UAIe container image, associating the UAIe container image with a cryptographic authentication token, launching an edge manager endpoint instance on the HPC system, and configuring the edge manager endpoint instance to allow external access to an ingress service based on the cryptographic authentication token. On the edge computing system side, the actions include the deployment of an UAIe instance and the use of the deployed UAIe instance to mount resources of the edge computing system to the edge computing system's file system and mount a shared file system of the HPC system to the edge computing system's file system.

More specifically, in accordance with example implementations, to set up the HPC system, a system administrator that has the appropriate credentials for the HPC system deploys an edge manager endpoint instance on the HPC system. The edge manager endpoint instance provides an ingress service that provides communication with the UAIe instance for purposes of exchanging data between the edge and HPC systems. In accordance with example implementations, the edge manager endpoint configures a service mesh gateway of the HPC system to provide external access to the ingress service. In accordance with example implementations, the system administrator may configure the service mesh gateway to expose an address (e.g., an Internet Protocol (IP) address or Uniform Resource Indicator (URI)) of the system for external access. The address (called an “external address”) may include a particular port number.

A system administrator for the HPC system may configure the service mesh gateway with an ingress authorization policy that sets forth one or multiple rules for controlling access by an external requestor to the ingress service's external address. In accordance with example implementations, the ingress authorization policy includes a rule that specifies that an access request directed to the external address of the ingress service is allowed for a requestor that provides the cryptographic authentication token but is denied otherwise.

A system administrator for the HPC system may further create a container image for the UAIe instance and store the container image in an image repository, or registry, of the HPC system. Moreover, in accordance with example implementations, the system administrator associates the cryptographic authentication token with the UAIe container image so that the authentication token is available for an authorized user of the UAIe image.

To set up the edge computing system, a user of the edge computing system, which has appropriate credentials, uses the UAIe container image to deploy an instance of the UAIe instance on the edge computing system. The user may then access the UAIe instance to remotely mount a file system of the HPC system to a file system of the edge computing system to create what is referred to herein as an “extended file system.” In an example, the remote mounting may use a file system client of the edge computing system. In an example the file system client may be a Secure Shell File system (SSHFS) client that uses a file transfer protocol (e.g., a Secure File Transfer Protocol (SFTP or Secure Copy Protocol (SCP) or other secure file transfer protocol) to transfer files between the edge computing and HPC systems. In an example, the edge computing system may have a LINUX operating system, and the SSHFS client may be a tool of the LINUX operating system package. In an example, the extended file system may be a file system in user space (FUSE). The configuration of the edge computing system may further include a user of the UAIe instance providing input to the UAIe instance for purposes of mounting resources (e.g., input devices and/or storage devices) of the edge computing system to the extended file system.

After the UAIe instance is deployed on the edge computing system, the UAIe instance connects to the ingress service of the HPC system. This connection process includes the UAIe instance providing the cryptographic authentication token, and the process includes the service mesh gateway of the HPC system authenticating the UAIe instance based on the cryptographic authentication token and registering the UAIe instance. Upon successful authentication of the UAIe instance, the HPC system initiates and maintains a tunnel connection with the UAIe instance. Through the tunnel connection, a platform service of the HPC system may provide application programming interface (API) requests to the UAIe instance for such purposes as using the extended file system to exchange data between the HPC system and the edge computing system.

In an example, the exchange of data may include transferring, from the edge computing system, files that contain input data that is consumed by jobs of the HPC system. In an example, the input data may represent inference data resulting from machine learning-based inference operations that are performed on the edge computing system. Compute nodes of the HPC system may process the input data for a number of reasons, such as machine learning model simulations, machine learning model training, machine learning model parameter tuning or other parallel processing operations that involve solving computationally complex problems. In another example, the exchange of data may include transferring, from the HPC system, files that contain data that is produced as an output by jobs of the HPC system. In an example, the output data may represent machine learning models, machine learning tuning parameters or other data that is consumed by processing operations on the edge computing system.

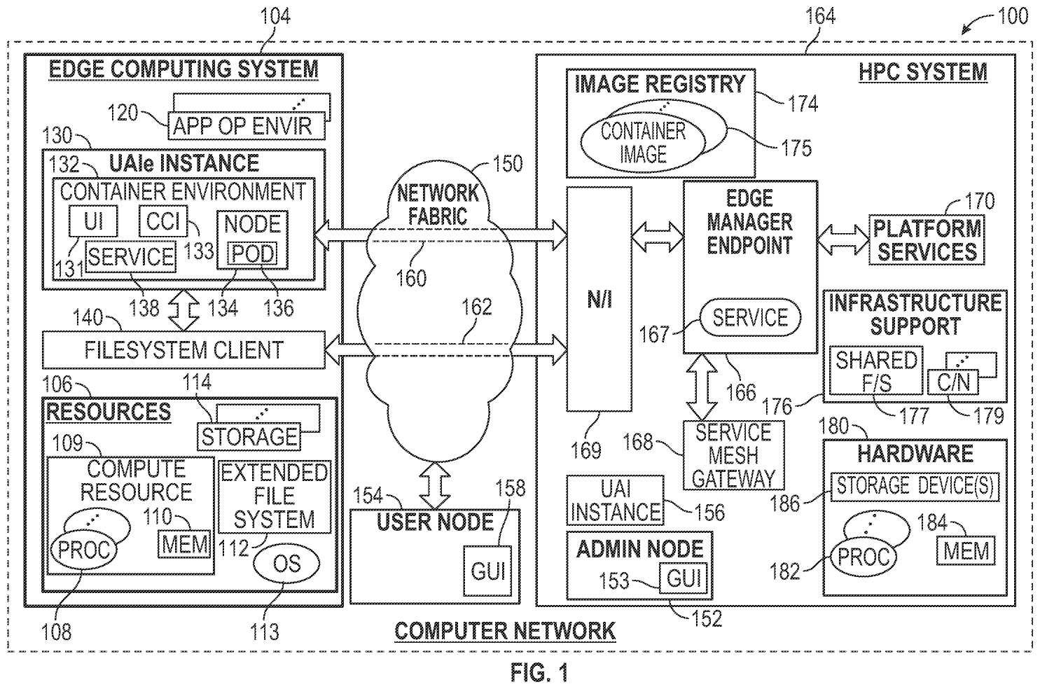

Referring to FIG. 1, a computer network 100 includes an edge computing system 104 and an HPC system 164. In accordance with example implementations, the edge computing system 104 and the HPC system 164 are located in different administrative domains. In an example, the HPC system 164 may be cloud-based and correspond to one or multiple data centers. In an example, the high-performance computing system may be an exascale computing system, which contains hundreds to thousands of compute nodes. In an example, the computer network 100 may be a wide area network (WAN), such as the Internet, and the edge computing system 104 may correspond to a local branch network. As depicted in FIG. 1, network fabric 150 may connect the edge computing system 104 and the HPC system 164. The network fabric 150 may be associated with one or multiple types of communication networks, such as (as examples) Fibre Channel networks, Compute Express Link (CXL) fabric, dedicated management networks, local area networks (LANs), WANs, global networks, wireless networks, or any combination thereof.

In the context that is used herein, an “edge computing system” refers to a system that is associated with entry points to a network, such as the computer network 100. In an example, the edge computing system 104 may be an instrumentation or experimental facility, and users of the edge computing system 104 may be scientists or researchers. Among its resources 106, the edge computing system 104 may include storage devices 114, compute resources 109, input devices, data capture devices, an operating system 113 and an extended file system 112 that includes directories on both the edge computing system 104 and the HPC system 164, as further described herein. In an example, the compute resources 109 may be nodes that process jobs related to machine learning model-based inference based on data that is captured by the edge computing system 104.

In an example, the HPC system 164 may provide elastic and scalable HPC services for the edge computing system 104. In an example, the HPC system 164 may include clusters of compute nodes 179, which perform parallel processing jobs for the edge computing system 104, such as machine learning model simulations, training and parameter tuning. These jobs consume input data that is provided by the edge computing system 104. The edge computing system 104 may consume the results of the output of the jobs, such as for example, data related to machine learning models that are used for inference, as well as the tuning adjustments for these models.

A user that is associated with the edge computing system 104 may develop, manage and launch one or multiple jobs for the HPC system 164 from a user node 154 (e.g., a computer platform, such as a laptop, desktop computer, tablet computing or other processor-based electronic device). In an example, the user node 154 may be a dedicated user access node (UAN) that is configured for general purpose multiple user access to the HPC system 164. In another example and as depicted in FIG. 1, the user node 154 may be a general purpose processing platform that is configured by a user access interface (UAI) instance 156 that is hosted on the HPC system 164. The UAI instance 156 may appear on-demand and may run short-term tasks or long-term tasks in connection with the HPC system 164 without dedicating the user node 154 for that purpose. In accordance with some implementations, the UAI instance 156 may connect to external storage by mounting storage within their containers but contain no persistent state of its own. As a result, the UAI instance 156 may be viewed as being disposable, as the UAI instance 156 may be started and stopped without loss of user data. As depicted in FIG. 1, the user node 154 may provide a graphical user interface (GUI) 158 (e.g., a GUI 158 provided by a web browser) to interact with the UAI instance 156.

FIG. 1 depicts a special purpose UAI instance, a UAIe instance 130, that may be deployed on the edge computing system 104 for purposes of extending a data plane of the HPC system 164 to the edge computing system 104. Moreover, the UAIe instance 130 provides a mechanism to exchange user environments of the edge computing system 104 and the HPC system 164. This extension of the data plane automates the exchange of data between the HPC system 164 and the edge computing system 104, as described herein. In accordance with example implementations, the UAIe instance 130 provides a user environment that has features that are taken from both the edge computing system 104 and the HPC system 164. In an example, the user environment that is provided by the UAIe instance 130 may have a certain “look and feel” that is familiar to users of the edge computing system 104, such as a certain software stack, a particular file system and certain access privileges. In an example, the user environment that is provided by the UAIe instance 130 may further have features that are familiar to the users of the HPC system 164, such as the HPC system's shared file system and certain access privileges.

In accordance with example implementations, the UAIe instance 130 provides a command-and-control interface 133 and a user interface 131. The command-and-control interface 133 receives and processes requests from the HPC system 164, which are related to transferring data (e.g., files) between the edge computing system 104 and the HPC system 164. The user interface 131, among other possible uses, allows a user associated with the edge computing system 104 to set up, or configure, the UAIe instance 130, as further described herein. In this context, “transferring data” between the edge computing system 104 and the HPC system 164 refers to a process that includes moving data from the edge computing system 104 to the HPC system 164, or vice versa. In example, a file may be transferred from the edge computing system 104 to the HPC system 164 by communicating data representing the file to the HPC system 164, and the transferring of data may or may not include removing or deleting the source file that is stored on the edge computing system 104. In another example, a file may be transferred from the HPC system 164 to the edge computing system 104 by communicating data representing the file to the edge computing system 104, and the transferring of data may or may not include removing or deleting the source file that is stored on the HPC system 164.

The command-and-control interface 133, in accordance with example implementations, communicates with the HPC system 164 over a network connection 160. In accordance with example, implementations, HPC system 164 may initiate and maintain a secure tunnel via the network connection 160. The secure tunnel maintains the privacy of data communicated between the UAIe instance 130 and the HPC system 164, even though the data may be communicated over a public network. In an example, the secure tunnel may be formed using a tunneling protocol. In examples, the tunneling protocol may be an Internet Protocol Security (IPSec) protocol, a Secure Socket Tunneling Protocol (SSTP) or another tunneling protocol that uses the payload portions of packets that correspond to a first protocol to carry packets that correspond to a different second protocol. In another example, the network connection 160 may be a Secure Shell (SSH) connection, and the secure tunnel may be an SSH tunnel.

Using the network connection 160, platform services 170 of the HPC system 164 may communicate requests to the command-and-control interface 133 of the UAIe instance 130 for a variety of purposes, including communicating requests with the UAIe instance 130 for purposes of exchanging data (e.g., files) between the edge computing system 104 and the HPC system 164. In an example, a platform service 170 may send, to the UAIe instance 130, a request containing a command for the UAIe instance 130 to initiate an operation to copy or move a file from the edge computing system 104 to the HPC system 164. In another example, a platform service 170 may send, to the UAIe instance 130, a request containing a command for the UAIe instance 130 to initiate an operation to copy or move a file from the HPC system 164 to the edge computing system 104. In another example, the UAIe instance 130 may send, to a platform service 170, an acknowledgement of a request that was sent by the platform service 170. In accordance with example implementations, files are exchanged between the edge computing system 104 and the HPC system 164 using a file system client 140 that is hosted on the edge computing system 104.

As depicted in FIG. 1, the file system client 140 communicates with the HPC system 164 over a network connection 162. In an example, the connection 162 may be an SSH connection. In this context, a “file system client” refers to a component of one computing system (e.g., the edge computing system 104) that is constructed to mount a file system of a remote computing system (e.g., the HPC system 164). In accordance with example implementations, the file system client 140 manages an extended file system 112, which includes file system directories that correspond to storage locations in both the edge computing system 104 and the HPC system 164.

As used herein, a “file” refers to a container of information, and a “file system” is a method and data structure to organize a collection of files. In an example, files in a file system may be organized using a directory, which is a hierarchical structure, or tree; and the location of a file within the file system may be identified by a corresponding file path. In an example, a file system may be a physical file system in which files conform to a particular data storage format. In another example, a file system may be a virtual file system which may be an upper file system layer of a composite file system that includes lower layer physical file systems that are accessed through the virtual file system. In an example, the edge computing system 104 may have a root file system, which contains files to boot the edge computing system 104, and other files systems may be mounted at mount points corresponding to subdirectories of the root file system.

In an example, for the LINUX operating system, the extended file system 112 may be a file system in user space (FUSE), which is a file system that may be created in user space without modifying the operating system kernel. The file system client 140, in accordance with example implementations, uses a network file transfer protocol to mount a file system of the HPC system 164 locally on the edge computing system 104. In this context, the “mounting” of the file system of the HPC system 164 refers to the binding of one or multiple directories of the file system to one or multiple locations, or mount points, of an otherwise local file system of the edge computing system 104. In an example, the file system client 140 may mount a directory or a directory tree of a shared file system 177 of the HPC system 164 to a directory (the “mount point” or “volume mount point”) of the edge computing system 104. The shared file system 177 may be shared by compute nodes 179 of the HPC system 164.

In an example, the file system client 140 may be a Secure Shell File system (SSHFS) client that uses a network file transfer protocol (e.g., a Secure File Transfer Protocol (SFTP or Secure Copy Protocol (SCP) or other secure network file transfer protocol) to transfer files between the edge computing system 104 and the HPC system 164. In an example, the UAIe instance 130 may correspond to a LINUX operating system, and the SSHFS client (the file system client 140) may be a tool of the LINUX operating system package. In another example, the file system client 140 may correspond to a standalone software entity that is not part of an operating system package.

In accordance with example, implementations, the UAIe instance 130 may, responsive to requests that are received by the command-and-control interface 133 from the HPC system 164, initiate operations to manage the exchange of files between the edge computing system 104 and the HPC system 164. In this context, “initiating” an operation refers to launching or beginning the operation. In an example, the UAIe instance 130 may, in a response to a particular request from the HPC system 164, generate one or multiple operating system commands to fulfill the request. In a more specific example, the UAIe instance 130 may be associated with a LINUX operating system, and the UAIe instance 130 may receive a request to copy a file from the edge computing system 104 to the HPC system 164. The file may be stored, for example, in a storage device 114 of the edge system 104, which corresponds to a particular directory of the extended file system 112, and the destination may correspond to a directory of the extended file system 112, which is associated with storage 116 of the HPC system 164. In response to the request, the UAIe instance 130 may issue a cp command with the appropriate arguments to the operating system. In accordance with example implementations, the UAIe instance 130 may respond to any of a variety of different file-related and file system-related requests by issuing corresponding operating system commands.

The user interface 131 of the UAIe instance 130 allows a user (e.g., a user of the user node 154 having the appropriate credentials) to access the UAIe instance 130 to configure the extended file system 112. In an example, when the UAIe instance 130 first starts up, a user may access the UAIe instance 130 through the user interface 131 to execute operating system commands to mount resources of the edge system 104 to what will become the extended file system 112. In an example, the user may enter one or multiple operating system commands (e.g., the make directory command, or mkdir command, for the LINUX operating system) to add one or multiple directories to the extended file system and mount input devices or other local resources of the edge computing system 104 to the directory (ies). The user may then enter commands to remotely mount the shared file system 177 of the HPC system 164. In an example, for the LINUX operating system, the user may first create a directory of the extended file system 112, which will be the mount point (e.g., create a directory using the mkdir command) and then enter the sshfs command to cause the file system client 140 to remotely mount the shared file system 177 of the HPC system 164. The sshfs command may specify a specify directory or directory tree of the shared file system 177 to mount to the mount point of the extended file system 112. In accordance with further implementations, instead of the user entering operating system commands, the user interface 131 of the UAIe instance 130 may receive other input (e.g., text input or input via manipulation of an input device, such as a touchpad or mouse) from the user and generate the correspond operating system commands to perform the operations indicated by the input.

The UAIe instance 130, when starting up, provides a connection request to the HPC system 104 for purposes of establishing the network connection 160. In accordance with example implementations, the UAIe instance 130 provides a cryptographic authentication token to the HPC system 104, which, as described further herein, the HPC system 104 uses to authenticate the UAIe instance 130. The cryptographic authentication token may be provided to the UAIe instance 130 in any of a number of different ways. In an example, a user may log into the user interface of the UAIe instance 130 with a set of credentials (e.g., a login ID and a password), and the UAIe instance 130 may look up the cryptographic authentication token based on the credentials. In another example, a user may, through the user interface of the UAIe instance 130, provide the cryptographic authentication token (e.g., provide by key input) to the UAIe instance 130. In another example, a user may, through the user interface of the UAIe instance 130, identify or upload a file containing the cryptographic authentication token.

In accordance with example implementations, the HPC system 104 includes an edge manager endpoint instance 166 that controls ingress access to the platform services 170 of the HPC system 164. In accordance with some implementations, the HPC system 164 includes a service mesh gateway instance 168 that controls, based on an authorization policy, whether a received network connection request (e.g., an incoming Transfer Control Protocol (TCP) connection request) from the network fabric 150 is allowed. If the authorization policy allows the request, then the service mesh gateway instance 168 forms the requested network connection, and otherwise, the service mesh gateway instance 168 denies the connection.

In an example, the service mesh gateway instance 168 is an ISITIO gateway that controls whether a network connection may be made to a service 167 of the edge manager endpoint instance 166 based on an ingress authorization policy. In an example, the service 167 may have an external address (e.g., a particular IP address or domain name, along with a port number), and the service 167 form a communication link with the platform services 170. In an example, the authorization policy may allow an external connection to the service 167 if the corresponding incoming request targets the service's external address and provides the appropriate authentical credential. In an example, the authorization policy may authorize a request by the UAIe instance 130 to connect to the service 167 responsive to a request providing a cryptographic authentication token that a system administrator of the HPC system 104 generated and associated with the UAIe's container image.

In accordance with example implementations, responsive to the service mesh gateway instance 168 successfully authenticating the UAIe instance 130, the edge manager endpoint instance 166 registers the UAIe instance 130. Moreover, the edge manager endpoint instance 166 may, responsive to the successful authentication, initiate and maintain a tunnel with the UAIe instance 130 for purposes of communicating messages (e.g., message containing file system-related and file transfer-related requests) between the platform services 170 and the UAIe instance 130.

A system administrator may access the HPC system 164 through an administrative node 152. In this manner, the administrative node 152 may contain GUI 153 (e.g., a GUI provided by a web browser) for purposes of allowing the system administrator to perform such actions as creating and configuring a container image 175 corresponding to the UAIe image 130 and storing the container image 175 in an image repository, or registry 174 of the HPC system 164. A system administrator for the HPC system 164 may further generate a cryptographic authentication token for the UAIe image 130 and store data in the image registry 174 or another data store, which represents the cryptographic authentication token and which may be accessed by an authorized user of the UAIe instance 130. Moreover, a system administrator for the HPC system 104 may configure a specific ingress authorization policy for the service mesh gateway instance 168 to allow a connection for a network request from the UAIe instance 130 when the request provides the cryptographic authentication token. Additionally, to complete setting up the HPC system 104 for use of the UAIe instance 130, a system administrator may launch the edge manager endpoint instance 166 that is configured by the specific ingress authorization policy.

In accordance with some implementations, the UAIe instance 130 is a container environment 132. In the context, a “container environment” refers to a collection of one or multiple instantiated containers (also referred to herein as “containers”). For a container environment that includes multiple containers, the containers may collaborate for a particular purpose (e.g., providing one or multiple microservices). In accordance with some implementations, a container environment may be orchestrated. An orchestrated container environment has an orchestrator that manages the lifecycles and workloads of the environment's containers. In examples, an orchestrator may manage provisioning and resource allocation for the containers. In other examples, an orchestrator may manage container replication, when containers start and stop, container scaling, workload distribution among the containers, or other lifecycle phase or workload aspects of the container environment. In examples, an orchestrated container environment may have a KUBERNETES orchestrator or a DOCKER SWARM orchestrator.

In accordance with some implementations, the UAIe instance 130 may be an orchestrated container environment that includes a cluster of worker nodes 134 (virtual or physical), and each worker node 134 of the cluster may host one or multiple groups of containers, called “container pods 136” The lifecycles of the worker nodes 134 may be managed by a control plane of an orchestrator (not shown). The container environment 132 may provide one or multiple services 138. In an example, a service 138 may correspond to a logical abstraction of a group of container pods 136 that perform the same function. In an example, one or multiple services 138 may provide the user interface 131 of the UAIe instance 130. In an example, one or multiple services 138 may provide the command-and-control interface 133. In an example, one or multiple services 138 may provide an interface that communicates with the file system client 140.

A container, in general, is a virtual run-time environment for one or multiple applications and/or application modules, and this virtual run-time environment is constructed to interface to an operating system kernel. A container for a given application may, for example, contain the executable code for the application and its dependencies, such as system tools, libraries, configuration files, executables and binaries for the application. The container contains an operating system kernel mount interface but not include an operating system kernel. As such, the UAIe instance 130 may, for example, contain multiple containers that share the kernel through respective operating system kernel mount interfaces. Docker containers and rkt containers are examples of containers.

In accordance with some implementations, the edge manager endpoint instance 166 may be may be an orchestrated container environment. The orchestrated container environment may provide the ingress service 167 and as well as one or multiple services corresponding to the service mesh gateway instance 168.

In accordance with further example implementations, one or both of the UAIe instance 130 and/or the edge manager endpoint instance 166 may not be container environments. In an example, in accordance with further implementations, the UAIe instance 130 may be executed on bare metal or within a virtual machine (and outside of a container).

Among the other features of the edge computing system 104, the compute resource 109 may be associated with one or multiple hardware processors 108 (e.g., central processing unit (CPU), processing cores, graphics processing unit (GPU) cores, or other processors) and a memory 110. In an example, the memory 110 is a non-transitory storage media that may be formed from semiconductor storage devices, memristor-based storage devices, magnetic storage devices, phase change memory devices, a combination of devices of one or more of these storage technologies, and so forth. The memory 110 may represent a collection of memories of both volatile memory devices and non-volatile memory devices. In accordance with some implementations, the memory 110 may store machine-readable instructions that, when executed by one or multiple hardware processors 108, cause the hardware processor(s) 108 to form software components of the edge computing system 104. As described further herein, these components may include the file system client 140, the UAIe instance 130 as well as one or multiple application operating environments 120 (e.g., bare metal environments, virtual machines or other virtualized environments).

In examples, a given storage device 114 of edge computing system 104 may be a hard drive, an optical drive, a solid state drive (SSD), a local attached storage device, a storage area network (SAN) or any other system or device that stores data.

Among its other features, the HPC system 164 may include a network interface 169. The network interface 169 may include one or multiple actual, or physical network devices (e.g., network interface controllers and gateways) as well as one or multiple virtual network devices. Hardware 180 of the HPC system 164 may include hardware processing cores 182 (e.g., CPU cores and/or GPU cores), a memory 184 and one or multiple storage devices 186. Similar to the storage device 114 of the edge computer system 104, given storage device 186 may be a hard drive, an optical drive, a solid state drive (SSD), a local attached storage device, a storage area network (SAN) or any other system or device that stores data. In general, the hardware 180 supports one or multiple platform services 170 that may be provided by the HPC system 164. Moreover, the platform services 170 may be supported by infrastructure support 176 of the HPC system 164. In an example, the infrastructure support 176 may include compute nodes 179, a shared file system 177 that is shared by the compute nodes 179, an operating system, a database layer, a hypervisor, or other infrastructure components. In an example, the platform services 170 may include services that are affiliated with HPC-as-a-Service (HPCaaS).

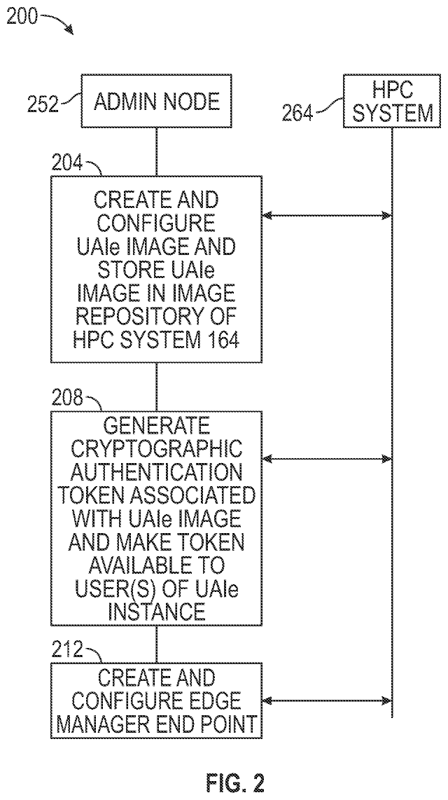

FIG. 2 is a sequence flow diagram 200 illustrating communications between an administrative node 252 and an HPC system 264 to set up the HPC system 264 to access an UAIe instance that hosted by edge computing system, according to an example implementation. Referring to FIG. 2, the sequence flow diagram 200 includes a system administrator for the HPC system 264 creating and configuring a UAIe image, as depicted at 204. Moreover, as also depicted at 204, the system administrator stores the UAIe image in an image repository of the HPC system 264.

Next, as depicted at 208, the setup of the HPC system 264 further includes the system administrator for the HPC system 264 may generate a cryptographic authentication token (e.g., a cryptographic key, digital certificate, or other cryptographic artifact containing an alphanumeric sequence) and associate the cryptographic authentication token with the UAIe image. In an example, the system administrator may associate HPC system access credentials of one or multiple edge system users with the cryptographic authentication token so that the users, when logged into the HPC system 264 may have access to the token.

The system administrator may next create and configure an edge manager endpoint for the HPC system 264, as depicted at 212. In an example, the system administrator may launch an edge manager endpoint instance on the HPC system 264 and configure the instance with an ingress authorization policy. In an example, the ingress authorization policy may specify a rule for a requestor that requests a connection to a particular address (e.g., a domain name or IP address, along with a port number) that corresponds to an ingress service. In an example the rule may require that the requestor provides the cryptographic authentication token for the connection to not be dropped and the requestor (e.g., an authorized UAIe instance) to be registered with the edge manager instance.

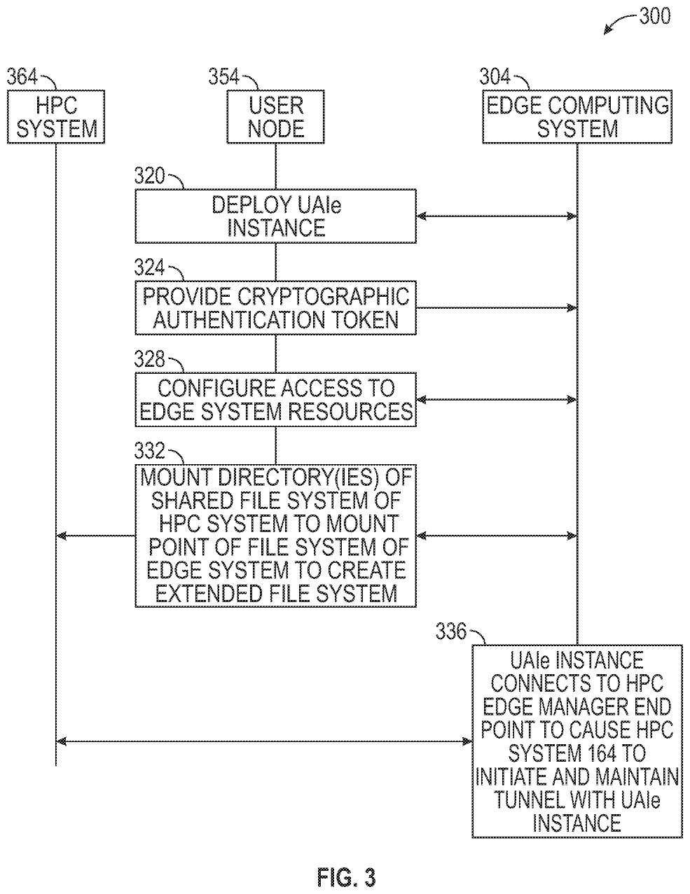

FIG. 3 is a sequence flow diagram 300 illustrating actions taken by an authorized user of an edge computing system 304, using a user node 354, to set up the edge computing system for communications with an edge manager endpoint instance of an HPC system 364, in accordance with example implementations. Referring to FIG. 3, the sequence 300 first includes the user deploying the UAIe instance on the edge computing system 304, as depicted at 320. In an example, the user may deploy the UAIe instance on the edge computing system 304 using Podman, CRI-O, DOCKER or another container engine.

After the UAIe instance is deployed on the edge computing system and started, the user next logs into the user interface of the UAIe instance and provides the cryptographic authentication token, as depicted at 324. The cryptographic authentication token may be provided to the UAIe instance in a number of different ways, such as by virtue of the login (e.g., the login credentials are mapped to hte cryptographic authentication token), the user providing the cryptographic authentication token via input, or the user identification a file or location that stores data representing the cryptographic authentication token.

The user may next, as depicted at 332, provide input to the UAIe instance to configure a file system (e.g., a FUSE) for the edge computing system 304, which includes one or multiple directories and/or directory trees of the HPC system 364. More specifically, in accordance with example implementations, the user may provide input to the UAIe instance to create one or multiple mount points for the edge computing system's file system and then mount these mount points to certain directories and/or directory trees of the HPC system's shared file system. In an example, creating mount points and remotely mounting to the HPC's shared file system may involve the user providing operating system commands that invoke operations that are performed by a file system client of the remote computing system. In another example, creating mount points and remotely mounting to the HPC's shared file system may involve the user providing input that causes the UAIe system to generate operating system commands that invoke operations that are performed by the file system client.

In accordance with example implementations, the UAIe instance may, in response to being provided the cryptographic authentication token, send a network connection request (with the cryptographic authentication token) to the edge manager endpoint instance of the HPC system 364 and connect to the edge manager endpoint instance, as depicted at 336. Although FIG. 3 depicts this occurring after the remote mounting-related operations, in general, the UAIe instance may connect to the edge manager endpoint instance any time after gaining access to the cryptographic authentication token. As also depicted at 336, the UAIe instance connecting with the edge manager endpoint instance causes the edge manager endpoint instance to initiate and maintain a tunnel with the UAIe instance. At the point, both the HPC system 364 and the edge computing system 304 are set up to extend the data plane of the HPC system 364 to the edge computing system 304.

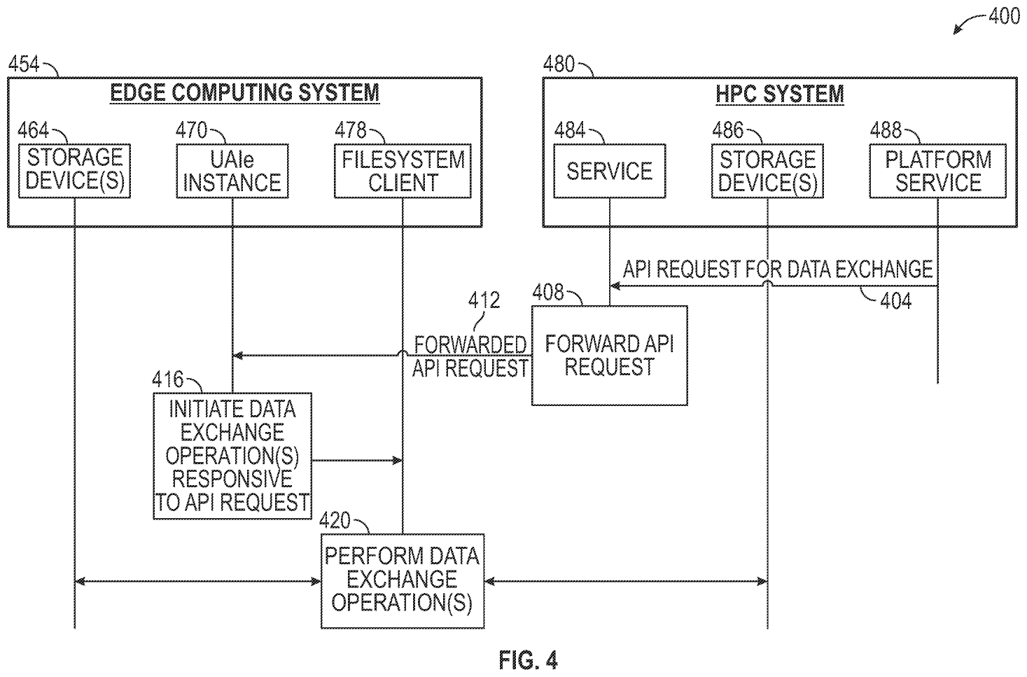

FIG. 4 is a sequence flow diagram 400 illustrating communications to exchange data between an HPC system 480 and an edge computing system 454 in accordance with example implementations. Referring to FIG. 4, as depicted at 404, a platform service 488 of the HPC system 480 generates an API request directed to data exchange between the HPC system 480 and the edge computing system 454. In an example, the platform service 488 be associated with a job scheduler, or manager. In an example, the API request may be directed to copying or moving a file that is stored on a storage device 464 of the edge computing system 454 to a storage device 486 of the HPC system 480. In an example, the moving or copying of the file may be associated with moving a file containing data that captured and processed by the edge computing system 454 and which serves as input to one or multiple parallel processing jobs that are performed by compute nodes of the HPC system 480. In an example, the moving or copying of the file may be associated with moving a file that contains data that produced by machine learning-based inference that is performed by the edge computing system 454 and which serves as input to one or multiple parallel processing jobs that are performed by compute nodes of the HPC system 480.

In another example, the API request may be directed to copying or moving a file that is stored on a file storage device 486 of the HPC system 480 to a file storage device 464 of the edge computing system 454. In an example, the moving or copying of the file may be associated with moving a file that contains data that represents a machine-learning model produced by parallel processing by compute nodes of the HPC system 480. In an example, the moving or copying of the file may be associated with moving a file that contains data that represents tuning parameters of a machine-learning model produced by parallel processing by compute nodes of the HPC system 480.

As depicted at 408 and 412, a service 484 of the HPC system 480 forwards the API request to a UAIe instance 470 that is hosted on the edge computing system 454. In an example, the service 484 may be a service of an edge manager endpoint instance of the HPC system 480, and the forwarding of the API request may involve communicating over a tunnel between the edge manager endpoint instance and the UAIe instance 470.

As depicted at 416, the UAIe instance 470, responsive to receiving the forwarded API request, initiates one or multiple data exchange operations responsive to the forwarded API request. In an example, the initiation of the data exchange operations may include the UAIe instance 470 generating one or multiple operating system commands. A file system client 478 of the edge computing system 454 may then respond to the initiation to perform the requested data exchange operation(s). In an example, the data exchange operation may correspond to an operation to copy or move a file from a directory that corresponds to a storage location of the edge computing system 454 to a directory that corresponds to a storage location of the HPC system 480, or vice versa. In an example, the file system client 478 may use a network file transfer protocol, such as an SFTP, to move or copy the data between the systems 454 and 480.

Although not depicted in FIG. 4, in accordance with some implementations, the UAIe instance 470 may communicate an acknowledgement message back to the platform service 488 via the network connection with the service 484. In an example, an acknowledgment may confirm receipt of the API request. In an example, an acknowledgment may confirm completion of the data exchange operation(s).

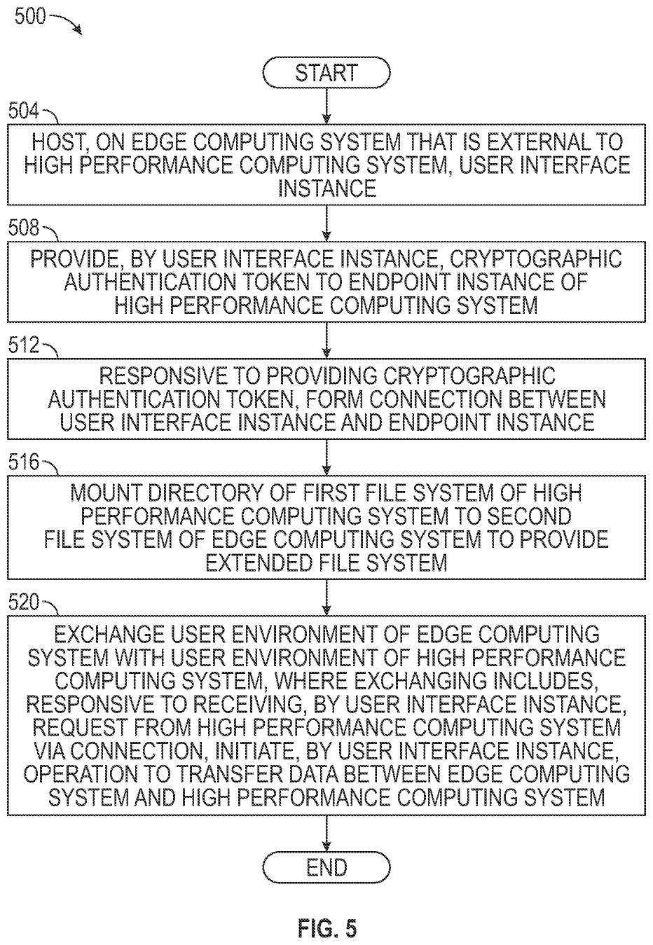

Referring to FIG. 5, in accordance with example implementations, a process 400 includes hosting (block 504), on an edge computing system that is external to a high-performance computing system, a user interface instance. In an example, the edge computing system may be an experimental or instrumentation edge facility that has significant compute, storage and networking resources, as compared to a resource-constrained edge computing system (e.g., an edge computing system of IoT devices). In an example, the edge computing system may perform machine learning model-based inference. In an example, the high-performance computing system may perform simulations of the machine learning-based model. In an example, the high-performance computing system may be an exascale computing system containing hundreds to thousands of compute nodes. In an example, the high-performance computing system may tune parameters of the machine learning model. In an example, the user interface instance may be a container environment. In an example, the container environment may include one or multiple container pods.

Pursuant to the block 508, the process 500 includes providing, by the user interface instance, a cryptographic authentication token to an endpoint instance of the high-performance computing system. In an example, the cryptographic authentication token may be a cryptographic key, digital certificate, or other cryptographic artifact containing an alphanumeric sequence. In an example, the endpoint instance may be a container environment. In an example, the endpoint instance may correspond to an edge manager for the high-performance computing system. In an example, the endpoint instance may configure a service mesh gateway of the high-performance computing system. In an example, the service mesh gateway may be an ISITIO service mesh gateway.

The process 500 further includes, pursuant to block 512, responsive to providing the cryptographic authentication token, forming a connection between the user interface instance and the endpoint instance. In an example, the endpoint instance may initiate and maintain a tunnel with the user interface instance. In an example, the tunnel may be formed using a tunneling protocol. In examples, the tunneling protocol may be an IPSec protocol, SSTP or another tunneling protocol that uses the payload portions of packets that correspond to a first protocol to carry packets that correspond to a different second protocol. In another example, the tunnel may be an SSH tunnel.

The process 500 includes mounting (block 516) a directory of a first file system of the high-performance computing system to a second file system of the edge computing system to provide an extended file system. In an example, the mounting may include mounting a one or multiple directories of the first file system to a volume mount point of the second file system. In an example, the second file system of the edge computing system may have one or multiple locations that correspond to resources of the edge computing system. In an example, the mounting includes the use of a file system client, such as an SSHFS client. In an example, the mounting includes using a network file transfer protocol, such as SFTP.

Pursuant to block 520, the process 500 includes exchanging a user environment of the edge computing system with a user environment of the high-performance computing system. The exchanging includes, responsive to receiving, by the user interface instance, a request from the high-performance computing system via the connection initiating, by the user interface instance, an operation to transfer data between the edge computing system and the high-performance computing system. In an example, the transfer of data may include transferring one or multiple files between the high-performance computing system and the edge computing system. In an example, the transfer of data may include transferring, from the edge computing system, a file that contains input for jobs that are processed by compute nodes of the high-performance computing system. In an example, the transfer of data may include transferring, from the high-performance computing system, a file that contains the output of jobs that are processed by compute nodes of the high-performance computing system.

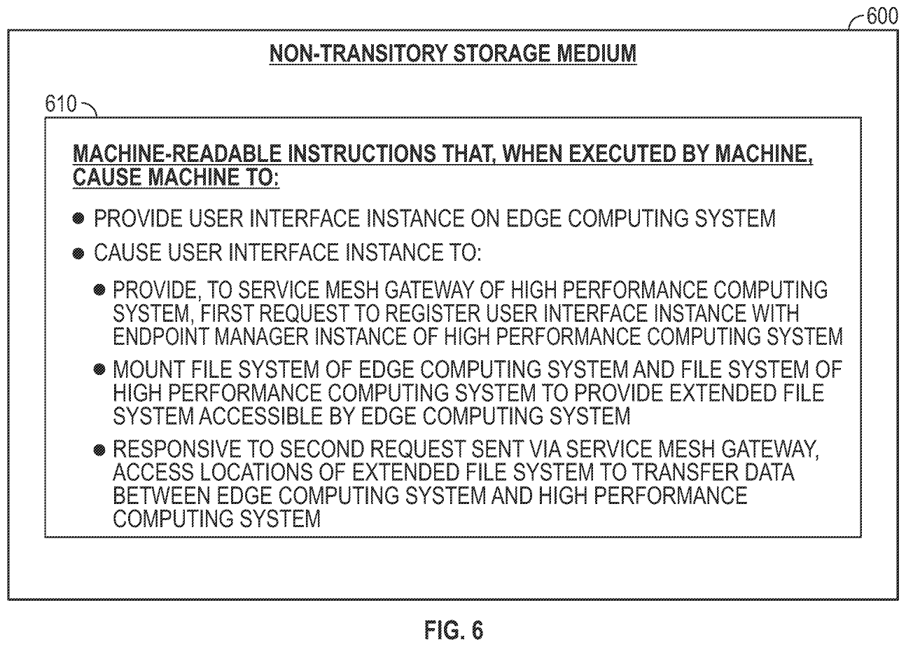

Referring to FIG. 6, in accordance with example implementations, a non-transitory storage medium 600 stores machine-readable instructions 610. The instructions 610, when executed by a machine, cause the machine to provide a user interface instance on an edge computing system. In an example, the edge computing system may be an experimental or instrumentation edge facility that has significant compute, storage and networking resources, as compared to a resource-constrained edge computing system (e.g., an edge computing system of IoT devices). In an example, the edge computing system may perform machine learning model-based inference. In an example, the high-performance computing system may perform simulations of the machine learning-based model. In an example, the high-performance computing system may be an exascale computing system containing hundreds to thousands of compute nodes. In an example, the high-performance computing system may tune parameters of the machine learning model. In an example, the user interface instance may be a container environment. In an example, the container environment may include one or multiple container pods. In an example, the user interface instance may provide one or multiple microservices. In an example, the user interface instance may be provided by an orchestrated cluster of worker nodes.

The instructions 610, when executed by the machine, further cause the machine to cause the user interface instance to provide, to a service mesh gateway of a high-performance computing system, a first request to register the user interface instance with an endpoint manager instance of the high-performance computing system. In an example, the endpoint manager instance may be a container environment. In an example, the endpoint manager instance may configure a service mesh gateway of the high-performance computing system to control external access to a service of the endpoint manager instance. In an example, the service mesh gateway may be an ISITIO service mesh gateway.

The instructions 610, when executed by the machine, further cause the machine to cause the user interface instance to mount a file system of the edge computing system and a file system of the high-performance computing system to provide an extended file system that is accessible by the edge computing system. In an example, the mounting may include mounting one or multiple directories of a file system of the high-performance system to a volume mount point of a file system of the edge computing system. In an example, the file system of the edge computing system may have one or multiple locations that correspond to resources of the edge computing system. In an example, the mounting includes the use of a file system client, such as an SSHFS client. In an example, the mounting includes using a network file transfer protocol, such as SFTP.

The instructions 610, when executed by the machine, further cause the machine to cause the user interface instance to responsive to a second request sent via the service mesh gateway, transfer data between locations of the extended file system to exchange data between the edge computing system and the high-performance computing system. In an example, the transfer of data may include transferring one or multiple files between the high-performance computing system and the edge computing system. In an example, the transfer of data may include transferring, from the edge computing system, a file that contains data representing input for jobs that are processed by compute nodes of the high-performance computing system. In an example, the transfer of data may include transferring, from the high-performance computing system, a file that contains data representing the output of jobs that are processed by compute nodes of the high-performance computing system.

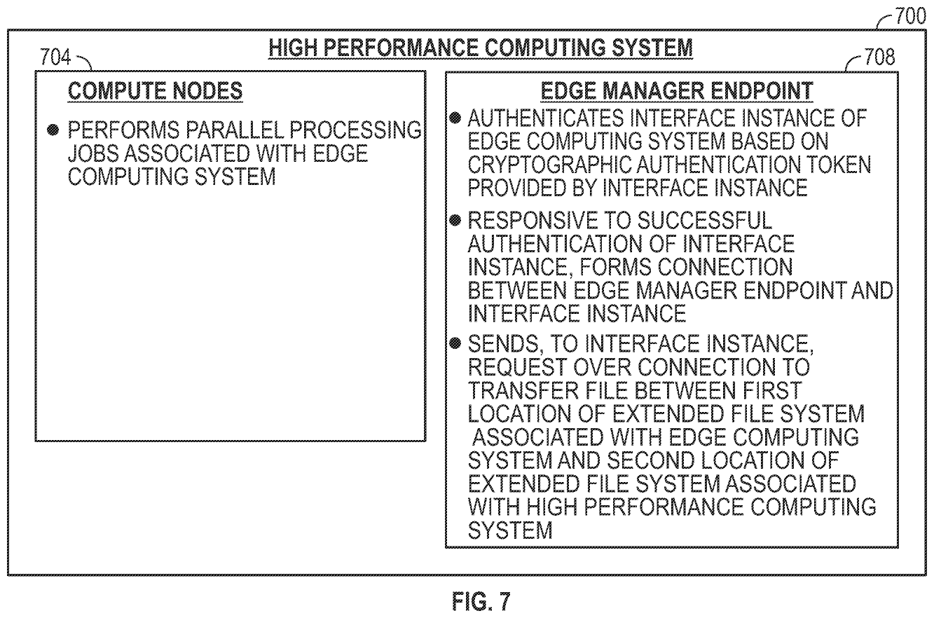

Referring to FIG. 7, in accordance with example implementations, a first computing system 700 includes a plurality of compute nodes 704 that perform parallel processing jobs associated with an edge computing system. In an example, the first computing system 700 may be a high-performance computing system. In an example, the compute nodes 704 may perform jobs related to machine learning model-based simulation. In an example, the compute nodes 704 may perform jobs related to tuning parameters of machine learning-based models. In an example, the first computing system 700 may be an exascale system that has hundreds to thousands of compute nodes 704.

The first computing system 700 further includes an edge manager endpoint 708. In an example, the edge manager endpoint 708 may be an instance corresponding to a container environment. The edge computing system manager endpoint 708 authenticates an interface instance of an edge computing system based on a cryptographic authentication token provided by the interface instance. In an example, the edge computing system may be an instrumentation or experimental facility. In an example, the edge computing system may perform machine learning model-based inference. In an example, the cryptographic authentication token may be a cryptographic key. In an example, the interface instance of the edge computing system may be a provided by a container environment. In an example, the interface instance may be provided by one or multiple container pods.

The edge manager endpoint 708, responsive to successful authentication of the interface instance, forms a connection between the edge manager endpoint and the interface instance. In an example, the endpoint manager endpoint 708 may initiate and maintain a tunnel with the user interface instance. In an example, the tunnel may be formed using a tunneling protocol. In examples, the tunneling protocol may be an IPSec protocol, SSTP or another tunneling protocol that uses the payload portions of packets that correspond to a first protocol to carry packets that correspond to a different second protocol. In another example, the tunnel may be an SSH tunnel.

The edge manager endpoint 708 sends, to the interface instance, a request over the connection to transfer a file between a first location of an extended file system associated with the edge computing system and a second location of the extended file system associated with the high-performance computing system. In an example, the request may cause multiple files to be transferred between the high-performance computing system and the edge computing system. In an example, the file may be transferred from the edge computing system, and the file may contain data representing input for jobs that are processed by compute nodes of the first computing system 700. In an example, the file may be transferred from the first computing system 700, and the file may contain data representing the output of jobs that are processed by compute nodes of the first computing system 700.

In accordance with example implementations, forming the connection between the user interface instance and the endpoint instance includes forming a connection with a service mesh gateway of the high-performance computing system. A particular advantage is that the data plane of the high-performance computing system may be extended to the edge computing system.

In accordance with example implementations, hosting the user interface includes hosting a container environment on the edge computing system. A particular advantage is that the data plane of the high-performance computing system may be extended to the edge computing system.

In accordance with example implementations, mounting the directory of the first file system includes communicating between the edge computing system and the high-performance computing system using a network file transfer protocol. A particular advantage is that the data plane of the high-performance computing system may be extended to the edge computing system.

In accordance with example implementations, a compute resource of the edge computing system is controlled responsive to a second request received by the first user interface instance from the connection. A particular advantage is that the data plane of the high-performance computing system may be extended to the edge computing system.

In accordance with example implementations, the user interface instance reports, over the connection, a status of an operation that is performed by a compute resource of the edge computing system. A particular advantage is that the data plane of the high-performance computing system may be extended to the edge computing system.

In accordance with example implementations, the high-performance computing system includes a plurality of compute nodes, and the second file system includes a file system that is shared by the plurality of compute nodes. A particular advantage is that the data plane of the high-performance computing system may be extended to the edge computing system.

In accordance with example implementations, a resource of the edge computing system is mounted, by the user interface instance, to the second file system. A particular advantage is that the data plane of the high-performance computing system may be extended to the edge computing system.

In accordance with example implementations, the mounting includes mounting a subdirectory of the first file system to a mount point of the second file system. A particular advantage is that the data plane of the high-performance computing system may be extended to the edge computing system.

In accordance with example implementations, machine learning inference is performed by the edge computing system. The machine learning inference is associated with a machine learning model. The high-performance computing system trains the machine learning model. A particular advantage is that the data plane of the high-performance computing system may be extended to the edge computing system.

In accordance with example implementations, transferring the data includes transferring data associated with machine learning inference from the edge computing system to the high-performance computing system. A particular advantage is that the data plane of the high-performance computing system may be extended to the edge computing system.

In accordance with example implementations, transferring the data includes transferring data associated with parameters of a machine learning model from the high-performance computing system to the edge computing system. A particular advantage is that the data plane of the high-performance computing system may be extended to the edge computing system.

In accordance with example implementations, initiating the operation includes initiating an operation to transfer data associated with the machine learning inference from the edge computing system to the high-performance computing system. A particular advantage is that the data plane of the high-performance computing system may be extended to the edge computing system.

In accordance with example implementations, initiating the operation includes initiating an operation to transfer data associated with parameters of the machine learning model from the high-performance computing system to the edge computing system. A particular advantage is that the data plane of the high-performance computing system may be extended to the edge computing system.

In accordance with example implementations, the user interface instance receives a request to transfer a file associated with the machine learning inference to the high-performance computing system. The file is transferred by the edge computing system to the high-performance computing responsive to the request. A particular advantage is that the data plane of the high-performance computing system may be extended to the edge computing system.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
hosting, on an edge computing system, a user interface instance;
providing, by the user interface instance, a cryptographic authentication token to an endpoint instance of a high-performance computing system external to the edge computing system;
responsive to providing the cryptographic authentication token, forming a connection between the user interface instance and the endpoint instance;
mounting a directory of a first file system of the high-performance computing system to a second file system of the edge computing system to provide an extended file system; and
responsive to receiving, by the user interface instance, a request from the high-performance computing system via the connection, initiating, by the user interface instance, an operation to exchange data between the edge computing system and the high-performance computing system.

2. The method of claim 1, wherein forming the connection between the user interface instance and the endpoint instance comprises forming a connection with a service mesh gateway of the high-performance computing system.

3. The method of claim 1, wherein hosting the user interface instances comprises hosting a container environment on the edge computing system.

4. The method of claim 1, wherein mounting the first file system comprises communicating between the edge computing system and the high-performance computing system using a network file transfer protocol.

5. The method of claim 1, further comprising:
responsive to a second request received by the user interface instance from the connection, controlling a compute resource of the edge computing system.

6. The method of claim 1, further comprising:
responsive to a compute resource of the edge computing system performing an operation, reporting, by the user interface instance and over the connection, a status of the operation.

7. The method of claim 1, wherein the high-performance computing system comprises a plurality of compute nodes, and the second file system comprises a file system shared by the plurality of compute nodes.

8. The method of claim 1, further comprising:
mounting, by the user interface instance, a resource of the edge computing system to the first file system.

9. The method of claim 1, wherein the mounting comprises mounting a subdirectory of the first file system to a mount point of the second file system.

10. The method of claim 1, further comprising:
performing, by the edge computing system, machine learning inference associated with a machine learning model; and
training, by the high-performance computing system, the machine learning model.

11. The method of claim 10, wherein initiating the operation comprises:
initiating an operation to transfer data associated with the machine learning inference from the edge computing system to the high-performance computing system.

12. The method of claim 10, wherein initiating the operation comprises:
initiating an operation to transfer data associated with parameters of the machine learning model from the high-performance computing system to the edge computing system.

13. The method of claim 10, further comprising:
receiving, by the user interface instance, a request to transfer a file associated with the machine learning inference to the high-performance computing system; and
transferring, by the edge computing system, the file to the high-performance computing responsive to the request.

14. A non-transitory storage medium that stores machine-readable instructions that, when executed by a machine, cause the machine to:
provide a user interface instance on an edge computing system;
cause the user interface instance to:
provide, to a service mesh gateway of a high-performance computing system, a first request to register the user interface instance with an endpoint manager instance of the high-performance computing system;
mount a file system of the edge computing system and a file system of the high-performance computing system to provide an extended file system accessible by the edge computing system; and
responsive to a second request sent via the service mesh gateway, move data between locations of the extended file system to exchange data between the edge computing system and the high-performance computing system.

15. The storage medium of claim 14, wherein the instructions, when executed by the machine, further cause the machine to, responsive to the communications, provide, to the high-performance computing system, data representing a file directory of the first file system.

16. The storage medium of claim 14, wherein the instructions, when executed by the machine, further cause the machine to transfer a file stored in a storage resource associated with the edge computing system to the high-performance computing system.

17. The storage medium of claim 14, wherein the instructions, when executed by the machine, further cause the machine to transfer a file stored in a storage resource associated with the high-performance computing system to the edge computing system.

18. A first computing system comprising:
a plurality of compute nodes that perform parallel processing jobs associated with an edge computing system; and
an edge manager endpoint that:
authenticates an interface instance of the edge computing system based on a cryptographic authentication token provided by the interface instance;
responsive to successful authentication of the interface instance, forms a connection between the edge manager endpoint and the interface instance; and
sends, to the interface instance, a request over the connection to move a file between a first location of an extended file system associated with the edge computing system and a second location of the extended file system associated with the first computing system.

19. The first computing system of claim 18, wherein:
the parallel processing jobs process input data provided by the edge computing system; and
the edge computing system manager, responsive to the access, transfers the input data from the edge computing system to the first computing system.

20. The first computing system of claim 18, wherein:
the edge computing system performs machine learning-based inference based on a machine learning model;
the parallel processing determines parameters for the machine learning model; and
the edge computing system manager, responsive to the access, transfers the data representing the parameters from the first computing system to the edge computing system.
